(19) United States
(12) Patent Application Publication
(10) Pub. No.: US 2005/0019657 A1
(43) Pub. Date: Jan. 27, 2005

(54) Nickel-hydrogen cell

(76) Inventors: Katsuhiko Shinyama, Kobe-city (JP); Hiroyuki Akita, Kobe-city (JP); Tadayoshi Tanaka, Takatsuki-city (JP); Yoshifumi Magari, Kobe-city (JP); Atsuhiro Funahashi, Toyonaka-city (JP); Toshiyuki Nohma, Kobe-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/498,262

(22) PCT Filed: Nov. 25, 2002
(86) PCT No.: PCT/JP02/12284

(30) Foreign Application Priority Data
Dec. 12, 2001 (JP) 2001-378600
Dec. 21, 2001 (JP) 2001-389942
Sep. 26, 2002 (JP) 2002-280624

(51) Int. Cl. H01M 4/58; H01M 10/26

(52) U.S. Cl. 429/218.2; 429/206

(57) ABSTRACT

A nickel-metal hydride battery provided with a positive electrode using nickel hydroxide, a negative electrode using hydrogen absorbing alloy, an alkaline electrolyte solution, and a separator 3 separating the positive electrode and the negative electrode, wherein use is made of the negative electrode and/or the alkaline electrolyte solution comprising Mo or W, the separator using sulfonized olefinic resin, and the positive electrode comprising hydroxide and/or oxide of at least one element selected from Ca, Sr, Sc, Y, lanthanoid and Bi.

### TECHNICAL FIELD

The present invention relates generally to a nickel-metal hydride battery provided with a positive electrode using nickel hydroxide, a negative electrode using hydrogen absorbing alloy, an alkaline electrolyte solution, and a separator separating the positive electrode and the negative electrode.

### BACKGROUND ART

Alkaline storage batteries such as nickel-metal hydride batteries, nickel-cadmium storage batteries, nickel-zinc storage batteries, have been used, and recently, the nickel-metal hydride batteries featuring high output and environmental safety have come into wide use as power sources for electric cars, hybrid cars, electric bicycles, electric tools, and so on.

Such nickel-metal hydride batteries have used nickel hydroxide as positive electrodes thereof, and hydrogen absorbing alloy as negative electrodes thereof.

However, in use of the nickel-metal hydride batteries at low temperature, there have remained problems that reaction velocity at which hydrogen absorbed in the hydrogen absorbing alloy is desorbed is lowered, and discharge characteristics at low temperature are extremely lowered.

In the past, Japanese Patent Publication No. 60-198066 proposed an alkaline storage battery provided with the negative electrode using cadmium and an alkaline electrolyte solution to which hydroxides of molybdenum and so on are added so as to improve charge efficiency of the battery after long period of storage.

Unfortunately, however, the publication proposed the alkaline storage battery using cadmium as the negative electrode, therefore, does not show modification of the reaction velocity at which hydrogen is desorbed from the hydrogen absorbing alloy at low temperature in the nickel-metal hydride battery provided with the negative electrode using hydrogen absorbing alloy.

In the storage of the aforesaid nickel-metal hydride batteries in a charged state, there have remained problems that oxygen generates in the positive electrode using nickel hydroxide, and the oxygen is absorbed into the negative electrode using hydrogen absorbing alloy, thus self discharge occurs and capacity is lowered, especially, in the storage under high temperature, amount of self discharge becomes larger, and capacity is steeply decreased.

Therefore, Japanese Patent Publication No. 1-132065 proposed the nickel-metal hydride battery provided with the negative electrode using hydrogen absorbing alloy to which tungsten powder is added so as to prevent the negative electrode from absorbing the oxygen which generates in the positive electrode, thus to prevent occurrence of the self discharge during the storage.

In addition, Japanese Patent Publication No. 8-88020 proposed the nickel-metal hydride battery provided with the alkaline electrolyte solution to which an ion selected form molybdenum ion, tungsten ion, and chromium ion is added so as to improve storage characteristics at high temperature.

However, even in the nickel-metal hydride battery provided with the negative electrode using hydrogen absorbing alloy to which tungsten powder is added, or the nickel-metal hydride battery provided with the alkaline electrolyte solution to which an ion selected form molybdenum ion, tungsten ion, and chromium ion is added, there have remained problems that generation of oxygen in the positive electrode is not sufficiently prevented, and the self discharge still occurs, especially, in the storage under high temperature, the amount of self discharge becomes larger.

Further, Japanese Patent Publication No. 62-115657 proposed the nickel-metal hydride battery provided with a separator using sulfonized olefinic resin so as to improve an affinity of the separator for the alkaline electrolyte solution, to prevent self discharge, and to improve cycle characteristics.

However, in use of the sulfonized olefinic resin as the separator, there have remained problems that when oxygen generates in the positive electrode, the separator is oxidized and degraded by the oxygen, thus the cycle characteristics are degraded.

An object of the present invention is to solve the above-mentioned various problems in the nickel-metal hydride battery provided with the positive electrode using nickel hydroxide, the negative electrode using hydrogen absorbing alloy, the alkaline electrolyte solution, and the separator separating the positive electrode and the negative electrode.

More specifically, an object of the present invention is to modify the discharge characteristics under low temperature, the storage characteristics especially under high temperature, and the cycle characteristics.

### DISCLOSURE OF THE INVENTION

A nickel-metal hydride battery according to a first aspect of the invention is provided with a positive electrode using nickel hydroxide, a negative electrode using hydrogen absorbing alloy, an alkaline electrolyte solution, and a separator separating the positive electrode and the negative electrode, wherein molybdenum is added to the negative electrode.

Where molybdenum is added to the negative electrode using hydrogen absorbing alloy, as suggested by the nickel-metal hydride battery of the first aspect of the invention, surface of the hydrogen absorbing alloy is activated for the effect of molybdenum and discharge characteristics of the nickel-metal hydride battery are modified, and especially, in use of the nickel-metal hydride battery under low temperature, hydrogen absorbed in the hydrogen absorbing alloy is desorbed quickly, thus, sufficient discharge capacity is attained even under low temperature.

Hydroxide and/or oxide of molybdenum are preferably added to the negative electrode using hydrogen absorbing alloy because when metal molybdenum is added, the metal molybdenum easily dissolves into the alkaline electrolyte solution.

In adding molybdenum to the negative electrode using hydrogen absorbing alloy, an insufficient amount of molybdenum results in a poor effect of modification of the discharge characteristics under low temperature, whereas an excessive amount of molybdenum results in decrease in ratio of the hydrogene absorbing alloy in the negative electrode thereby resulting in the decrease in capacity per unit weight. Therefore, the amount of molybdenum element based on the hydrogen absorbing alloy is preferably set in a range of 0.01 to 2 wt %.

A nickel-metal hydride battery according to a second aspect of the invention is provided with a positive electrode using nickel hydroxide, a negative electrode using hydrogen absorbing alloy, an alkaline electrolyte solution, and a separator separating the positive electrode and the negative electrode, wherein hydroxide and/or oxide of at least one element selected from calcium, strontium, scandium, yttrium, lanthanoid, and bismuth is added to the positive electrode, and molybdenum is added to at least one of the negative electrode and the alkaline electrolyte solution.

Where molybdenum is added to the negative electrode or the alkaline electrolyte solution, as suggested by the nickel-metal hydride battery of the second aspect of the invention, a surface of the hydrogen absorbing alloy is activated for the effect of the molybdenum thus added, thus discharge characteristics of the nickel-metal hydride battery are modified in the same manner as the nickel-metal hydride battery of the first aspect. In addition, where the hydroxide and/or oxide of at least one element selected from calcium, strontium, scandium, yttrium, lanthanoid, and bismuth is added to the positive electrode using nickel hydroxide, generation of oxygen in the positive electrode during charge or storage is prevented for the effect of the additive, thus oxidation and degradation of the hydrogen absorbing alloy used as the negative electrode is prevented.

As a result, activation of the surface of the hydrogen absorbing alloy to which molybdenum is added is further promoted, and the discharge characteristics are further modified, thus high discharge capacity under low temperature is attained, and cycle characteristics of the nickel-metal hydride battery are improved.

A nickel-metal hydride battery according to a third aspect of the invention is provided with a positive electrode using nickel hydroxide, a negative electrode using hydrogen absorbing alloy, an alkaline electrolyte solution, and a separator separating the positive electrode and the negative electrode, wherein hydroxide and/or oxide of at least one element selected from calcium, strontium, scandium, yttrium, lanthanoid, and bismuth is added to the positive electrode, and tungsten is added to at least one of the negative electrode and the alkaline electrolyte solution.

Where the hydroxide and/or oxide of at least one element selected from calcium, strontium, scandium, yttrium, lanthanoid, and bismuth is added to the positive electrode, as suggested by the nickel-metal hydride battery of the third aspect of the invention, generation of oxygen in the positive electrode during charge or storage is prevented. Further, where tungsten is added to the negative electrode or the alkaline electrolyte solution, oxygen reacts with hydrogen in the negative electrode and is consumed for catalysis of the tungsten, thus oxidation and degradation of the hydrogen absorbing alloy in the negative electrode is prevented.

As a result of prevention of the oxygen generation in the positive electrode and the prevention of degradation of the hydrogen absorbing alloy in the negative electrode, self discharge reaction during the storage hardly occurs, thus storage characteristics of the nickel-metal hydride battery are extremely improved, and even in the storage under high temperature, decrease of the capacity caused of the self discharge is steeply declined, and the cycle characteristics of the nickel-metal hydride battery are improved.

Hydroxide and/or oxide of tungsten is preferably added to the negative electrode or the alkaline electrolyte solution so as not to damage the nickel-metal hydride battery.

In adding tungsten to the negative electrode, an insufficient amount of tungsten results in poverty in the aforesaid effects, whereas an excessive amount of tungsten results in decrease in ratio of the hydrogen absorbing alloy in the negative electrode and the decrease in the capacity per unit weight. Therefore, the amount of tungsten element based on hydrogen absorbing alloy is preferably set in a range of 0.01 to 2 wt %.

A nickel-metal hydride battery according to a fourth aspect of the invention is provided with a positive electrode using nickel hydroxide, a negative electrode using hydrogen absorbing alloy, an alkaline electrolyte solution, and a separator separating the positive electrode and the negative electrode, wherein sulfonized olefinic resin is used as the separator, and at least one of molybdenum and tungsten is added to at least one of the negative electrode and the alkaline electrolyte solution.

Where the sulfonized olefinic resin is used as the separator, as suggested by the nickel-metal hydride battery of the fourth aspect of the invention, an affinity of the separator for the alkaline electrolyte solution is improved, thus self discharge is prevented and cycle characteristics are improved. In addition, where at least one of molybdenum and tungsten is added to at least one of the negative electrode and the alkaline electrolyte solution, oxygen which generates in the positive electrode reacts with hydrogen in the negative electrode and is consumed for catalysis of the molybdenum or the tungsten, thus degradation of the separator by the oxygen is prevented, and oxidation and degradation of the hydrogen absorbing alloy in the negative electrode is prevented.

As a result self discharge reaction during storage hardly occurs, storage characteristics of the nickel-metal hydride battery are extremely improved, and cycle characteristics of the nickel-metal hydride battery are greatly improved.

Hydroxide and/or oxide of molybdenum or tungsten is preferably added to the negative electrode or the alkaline electrolyte solution so as not to damage the nickel-metal hydride battery.

In adding molybdenum or tungsten to the negative electrode or the alkaline electrolyte solution, an insufficient amount of molybdenum or tungsten results in difficulty in sufficient consumption of oxygen which generates in the positive electrode, whereas an excessive amount of molybdenum or tungsten results in decrease in conductivity in the alkaline electrolyte solution or decrease in reaction of the negative electrode. Therefore, the total amount of molybdenum and tungsten based on the hydrogen absorbing alloy in the negative electrode is preferably in a range of 0.08 to 0.59 wt %, especially, in the range of 0.3 to 0.4 wt % is more preferable.

Where hydroxide and/or oxide of at least one element selected from calcium, strontium, scandium, yttrium, lanthanoid, and bismuth is added to the positive electrode using nickel hydroxide of the nickel-metal hydride battery of the fourth aspect of the invention, generation of oxygen in the positive electrode during charge or storage is prevented for the effect of the additive, thus oxidation and degradation of the separator is further prevented, and oxidation and degradation of the hydrogen absorbing alloy in the negative electrode is further prevented, thus cycle characteristics of the nickel-metal hydride battery are further improved.

In adding the hydroxide and/or oxide of at least one element selected from calcium, strontium, scandium, yttrium, lanthanoid, and bismuth to the positive electrode using nickel hydroxide of each of the aforesaid nickel-metal hydride batteries, where at least a part of a surface of the positive electrode is coated with the additive, the generation of oxygen in the positive electrode during charge or storage is further prevented, especially, at least a part of the surface of the positive electrode is preferably coated with hydroxide and/or oxide of yttrium.

### BRIEF DESCRIPTION OF THE DRAWINGS

FIG. 1 is a schematic cross section of a nickel-metal hydride battery according to Examples and Comparative Examples of the present invention.

### BEST MODES FOR CARRYING OUT THE INVENTION

The following examples specifically illustrate nickel-metal hydride batteries according to the present invention. Further, comparative examples will be taken to make it clear that the nickel-metal hydride batteries according to the examples are superior. It should be appreciated that the nickel-metal hydride batteries according to the present invention are not particularly limited to those in the following examples, and various changes and modifications may be made in the invention without departing from the spirit and scope thereof.

### EXAMPLE A1

In Example A1, there were used a positive electrode and a negative electrode prepared in the following manners.

[Preparation of Positive Electrode]

In the preparation of a positive electrode, a sintered nickel substrate having a porosity of 85% was impregnated with a nickel nitrate aqueous solution having cobalt nitrate and zinc nitrate added thereto by chemically impregnating method to fill nickel hydroxide-based positive electrode active material into the sintered nickel substrate.

The sintered nickel substrate filled with the positive electrode active material was immersed into an aqueous solution containing 3 wt % of yttrium nitrate, was immersed into an aqueous solution containing 25 wt % of NaOH heated to 80° C., to prepare a positive electrode in which a coating layer of yttrium hydroxide Y(OH)₃ was formed on the positive electrode active material which was filled into the sintered nickel substrate. In the positive electrode, the amount of yttrium hydroxide based on total amount of the positive electrode active material and yttrium hydroxide was about 3 wt %.

[Preparation of Negative Electrode]

In the preparation of a negative electrode, there were used Ni, Co, Al, Mn, and Mm (misch metal) containing La, Ce, Pr, and Nd in a weight ratio of 25:50:6:19, to attain hydrogen absorbing alloy particles represented by a constitutional formula NmNi_{3.2}Co_{1.0}Al_{0.2}Mn_{0.6} and having an average particle diameter of about 50 μm.

100 parts by weight of the hydrogen absorbing alloy particles, 0.5 parts by weight of molybdenum oxide MoO₃, 1.0 part by weight of polyethylene oxide as a binding agent, and a little water were mixed together to prepare a paste, and the paste thus prepared was applied uniformly to both surfaces of a current collector using a nickel-plated punched metal. The paste on the current collector was then dried and rolled, to prepare a negative electrode in which molybdenum oxide was added to the hydrogen absorbing alloy. In the negative electrode, weight of molybdenum element in the molybdenum oxide based on the hydrogen absorbing alloy was 0.33 wt %.

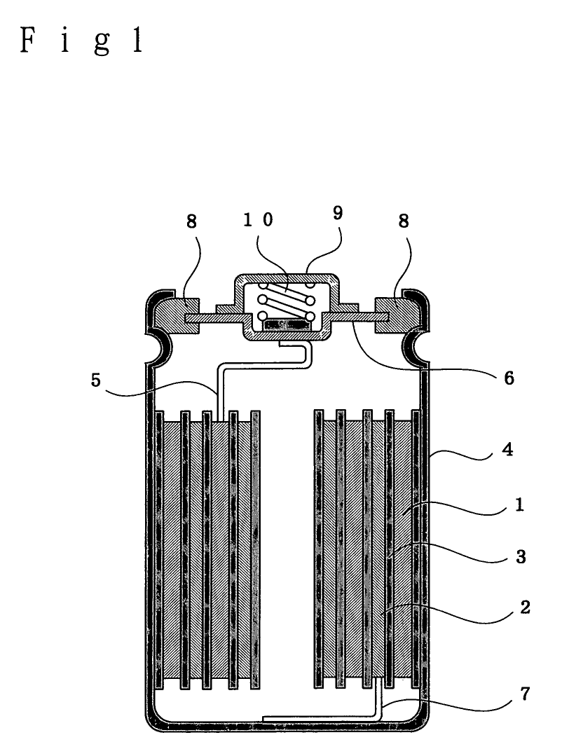

In addition, there were used a non-woven fabric of polypropylene, polyethylen, and ethylen vinyl alcohol copolymer as a separator separating the positive electrode and the negative electrode, and an aqueous solution of 30 wt % potassium hydroxide as an alkaline electrolyte solution, to fabricate a cylindrical nickel-metal hydride battery having a capacity of about 1000 mAh as shown in FIG. 1.

In the fabrication of the nickel-metal hydride battery, the separators 3 was interposed between the positive electrode 1 and the negative electrode 2 and was spirally wound, was contained in a negative electrode can 4, and was then sealed after pouring the alkaline electrolyte solution into the negative electrode can 4, as shown in FIG. 1. Subsequently, the positive electrode 1 was connected to a sealing cover 6 through a positive electrode lead 5 while the negative electrode 2 was connected to the negative electrode can 4 through a negative electrode lead 7. The negative electrode can 4 and the sealing cover 6 were electrically insulated from each other by an insulating packing 8, and a coil spring 10 was provided between the sealing cover 6 and a positive electrode external terminal 9. When the internal pressure of the battery abnormally rose, the coil spring 10 was compressed, so that gas inside the battery was released in the air.

### EXAMPLE A2

In Example A2, in the preparation of the positive electrode of Example A1, the coating layer of yttrium hydroxide Y(OH)₃ was not formed on the positive electrode active material which was filled into the sintered nickel substrate. Except for the above, the same procedure as that in the Example A1 was taken to fabricate a nickel-metal hydride battery of Example A2.

### COMPARATIVE EXAMPLE a1

In Comparative Example a1, in the preparation of the negative electrode of Example A1, molybdenum oxide MoO₃ was not added to the hydrogen absorbing alloy particles. Except for the above, the same procedure as that in the Example A1 was taken to fabricate a nickel-metal hydride battery of Comparative Example a1.

### COMPARATIVE EXAMPLE a2

In Comparative Example a2, in the preparation of the negative electrode of Example A1, molybdenum oxide MoO₃ was not added to the hydrogen absorbing alloy particles, and in the preparation of the positive electrode of Example A1, the coating layer of yttrium hydroxide Y(OH)₃ was not formed on the positive electrode active material which was filled into the sintered nickel substrate. Except for the above, the same procedure as that in the Example A1 was taken to fabricate a nickel-metal hydride battery of Comparative Example a2.

Each of the nickel-metal hydride batteries of Examples A1 to A2 and Comparative Examples a1 to a2 thus fabricated was charged at 100 mA for 16 hours and then discharged at 100 mA to 1.0 V under a temperature condition of 25° C. The above-mentioned charging and discharging was considered as one cycle. 10 cycles of the charging and discharging were performed, so as to activate each of the nickel-metal hydride batteries of Examples A1 to A2 and Comparative Examples a1 to a2.

Each of the nickel-metal hydride batteries of Examples A1 to A2 and Comparative Examples a1 to a2 thus activated was charged at 500 mA for 2.4 hours under the temperature condition of 25° C., was stored in an atmosphere of 0° C. for 2 hours, and was discharged at 10 A to 0.8 V under the temperature condition of 0° C., so as to measure the discharge capacity (mAh) under low temperature. The results were shown in the following Table 1.

TABLE 1

| | | | discharge |
|---|---|---|---|
| | MoO₃ in | Y(OH)₃ in | capacity under |
| | negative | positive | low temperature |
| | electrode | electrode | (mAh) |
| Example A1 | Yes | Yes | 764 |
| Example A2 | Yes | No | 501 |
| Comparative | No | Yes | 126 |
| Example a1 | | | |
| Comparative | No | No | 117 |
| Example a2 | | | |

As apparent from the results, the nickel-metal hydride batteries of Examples A1 and A2 using the negative electrode in which molybdenum oxide MoO₃ was added to the hydrogen absorbing alloy presented an improved discharge capacity under low temperature compared with the nickel-metal hydride batteries of Comparative Examples a1 and a2 using the negative electrode in which molybdenum oxide MoO₃ was not added to the hydrogen absorbing alloy.

In addition, according to a comparison between the nickel-metal hydride batteries of Examples A1 and A2, the nickel-metal hydride battery of Example A1 using the positive electrode in which the coating layer of yttrium hydroxide Y(OH)₃ was formed on the positive electrode active material which was filled into the sintered nickel substrate presented further improved discharge capacity under low temperature compared with the nickel-metal hydride battery of Example A2 using the positive electrode in which the coating layer of yttrium hydroxide Y(OH)₃ was not formed on the positive electrode active material.

Although the nickel-metal hydride battery of Example A1 showed formation of the coating layer of yttrium hydroxide Y(OH)₃ on the positive electrode active material, the same result is attained by use of yttrium oxide, hydroxide and/or oxide of at least one element selected from calcium, strontium, scandium, lanthanoid, and bismuth.

### EXAMPLE B1

In Example B1, there were used a positive electrode and a negative electrode prepared in the following manners.

[Preparation of Positive Electrode]

In the preparation of a positive electrode, a sintered nickel substrate having a porosity of 85% was impregnated with a nickel-nitrate aqueous solution having cobalt nitrate and zinc nitrate added thereto by chemically impregnating method to fill nickel hydroxide-based positive electrode active material into the sintered nickel substrate.

The sintered nickel substrate filled with the positive electrode active material was immersed into an aqueous solution containing 3 wt % of yttrium nitrate, and was immersed into the aqueous solution containing 25 wt % of NaOH heated to 80° C., to prepare a positive electrode in which a coating layer of yttrium hydroxide Y(OH)₃ was formed on the positive electrode active material which was filled into the sintered nickel substrate. In the positive electrode, the amount of yttrium hydroxide Y(OH)₃ based on total amount of the positive electrode active material and yttrium hydroxide Y(OH)₃ was about 3 wt %.

[Preparation of Negative Electrode]

In the preparation of a negative electrode, there were used Ni, Co, Al, Mn, and Mm (misch metal) containing La, Ce, Pr, and Nd in a weight ratio of 25:50:6:19, to attain hydrogen absorbing alloy particles represented by a constitutional formula MmNi_{3.2}Co_{1.0}Al_{0.2}Mn_{0.6} and having an average particle diameter of about 50 μm.

100 parts by weight of the hydrogen absorbing alloy particles, 0.5 part by weight of tungsten oxide WO₃, 1.0 part by weight of polyethylene oxide as a binding agent, and a little water were mixed together to prepare a paste, and the paste thus prepared was applied uniformly to both surfaces of a current collector using a nickel-plated punched metal. The paste on the current collector was then dried and rolled, to prepare a negative electrode in which tungsten oxide WO₃ was added to the hydrogen absorbing alloy. In the negative electrode, weight of tungsten element in tungsten oxide WO₃ based on the hydrogen absorbing alloy was 0.40 wt %.

In addition, there were used a non-woven fabric of polypropylene, polyethylen, and ethylen vinyl alcohol copolymer as a separator separating the positive electrode and the negative electrode, and an aqueous solution of 30 wt % potassium hydroxide as an alkaline electrolyte solution. Except for the above, the same procedure as that in the Example A1 was taken to fabricate a cylindrical nickel-metal hydride battery having a capacity of about 1000 mAh.

### COMPARATIVE EXAMPLE b1

In Comparative Example b1, in the preparation of the negative electrode of Example B1, tungsten oxide WO₃ was not added to the hydrogen absorbing alloy particles. Except for the above, the same procedure as that in the Example B1 was taken to fabricate a nickel-metal hydride battery of Comparative Example b1. The nickel-metal hydride battery of Comparative Example b1 is the same as that of Comparative Example a1.

### COMPARATIVE EXAMPLE b2

In Comparative Example b2, in the preparation of the positive electrode of Example B1, the coating layer of yttrium hydroxide Y(OH)₃ was not formed on the positive electrode active material which was filled into the sintered nickel substrate. Except for the above, the same procedure as that in the Example B1 was taken to fabricate a nickel-metal hydride battery of Comparative Example b2.

### COMPARATIVE EXAMPLE b3

In Comparative Example b3, in the preparation of the negative electrode of Example B1, tungsten oxide WO₃ was not added to the hydrogen absorbing alloy particles, and in the preparation of the positive electrode of Example B1, the coating layer of yttrium hydroxide Y(OH)₃ was not formed on the positive electrode active material which was filled into the sintered nickel substrate. Except for the above, the same procedure as that in the Example B1 was taken to fabricate a nickel-metal hydride battery of Comparative Example b3. The nickel-metal hydride battery of Comparative Example b3 is the same as that of Comparative Example a2.

Each of the nickel-metal hydride batteries of Example B1 and Comparative Examples b1 to b3 thus fabricated was charged at 100 mA for 16 hours and then discharged at 100 mA to 1.0 V under a temperature condition of 25° C. The above-mentioned charging and discharging was considered as one cycle. 10 cycles of the charging and discharging were performed, so as to activate each of the nickel-metal hydride batteries of Example B1 and Comparative Examples b1 to b3.

Each of the nickel-metal hydride batteries of Example B1 and Comparative Examples b1 to b3 thus activated was charged at 500 mA for 1.6 hours under the temperature condition of 25° C., was discharged at 500 mA to 1.0 V under the temperature condition of 25° C., so as to measure the discharge capacity Qa (mAh) before storage. Then, each of the nickel-metal hydride batteries was charged at 500 mA for 1.6 hours under the temperature condition of 25° C., was stored for 10 days under the temperature condition of 45° C., then was discharged at 500 mA to 1.0 V under the temperature condition of 25° C., so as to measure the discharge capacity Qb (mAh) after storage.

Percentage of self discharge (%) of each of the nickel-metal hydride batteries of Example B1 and Comparative Examples b1 to b3 was found by way of the following formula. The results were shown in the following Table 2. Qo is 1000 mAh according to above design capacity.

Percentage of self discharge (%)=(Qa−Qb)×100/Qo

TABLE 2

| | WO₃ in | Y(OH)₃ in | Percentage of |
|---|---|---|---|
| | negative | positive | self |
| | electrode | electrode | discharge (%) |
| Example B1 | Yes | Yes | 24 |
| Comparative | No | Yes | 40 |
| Example b1 | | | |
| Comparative | Yes | No | 41 |
| Example b2 | | | |
| Comparative | No | No | 49 |
| Example b3 | | | |

As apparent from the results, the nickel-metal hydride battery of Example B1 using the positive electrode in which the coating layer of yttrium hydroxide Y(OH)₃ was formed on the positive electrode active material which was filled into the sintered nickel substrate, and using the negative electrode in which tungsten oxide WO₃ was added to the hydrogen absorbing alloy particles presented an extreme decrease in the percentage of self discharge after the storage under high temperature conditions compared with the nickel-metal hydride battery of Comparative Example b3 using the negative electrode in which tungsten oxide WO₃ was not added to the hydrogen absorbing alloy particles and the positive electrode in which the coating layer of yttrium hydroxide Y(OH)₃ was not formed on the positive electrode active material which was filled into the sintered nickel substrate, the nickel-metal hydride battery of Comparative Example b1 using only the positive electrode in which the coating layer of yttrium hydroxide Y(OH)₃ was formed on the positive electrode active material which was filled into the sintered nickel substrate, and the nickel-metal hydride battery of Comparative Example b2 using the negative electrode in which tungsten oxide WO₃ was added to the hydrogen absorbing alloy particles.

Although the nickel-metal hydride battery of Example B1 showed formation of the coating layer of yttrium hydroxide Y(OH)₃ on the positive electrode active material, the same result is attained by use of yttrium oxide, hydroxide and/or oxide of at least one element selected from calcium, strontium, scandium, lanthanoid, and bismuth.

### EXAMPLE C1

In Example C1, there were used a positive electrode and a negative electrode prepared in the following manners.

[Preparation of Positive Electrode]

In the preparation of a positive electrode, a sintered nickel substrate having a porosity of 85% was impregnated with a nickel nitrate aqueous solution having cobalt nitrate and zinc nitrate added thereto by chemically impregnating method, to fill nickel hydroxide-based positive electrode active material into the sintered nickel substrate.

The sintered nickel substrate filled with the positive electrode active material was immersed into an aqueous solution containing 3 wt % of yttrium nitrate, and was immersed into the aqueous solution containing 25 wt % of NaOH heated to 80° C., to prepare a positive electrode in which a coating layer of yttrium hydroxide Y(OH)₃ was formed on the positive electrode active material which was filled into the sintered nickel substrate. In the positive electrode, the amount of yttrium hydroxide Y(OH)₃ based on total amount of the positive electrode active material and yttrium hydroxide Y(OH)₃ was about 3 wt %.

[Preparation of Negative Electrode]

In the preparation of a negative electrode, there were used Ni, Co, Al, Mn, and Mm (misch metal) containing La, Ce, Pr, and Nd in a weight ratio of 25:50:6:19, to attain hydrogen absorbing alloy particles represented by a constitutional formula MmNi_{3.2}Co_{1.0}Al_{0.2}Mn_{0.6} and having an average particle diameter of about 50 μm.

100 parts by weight of the hydrogen absorbing alloy particles, 1.0 part by weight of polyethylene oxide as a binding agent, and a little water were mixed together to prepare a paste, and the paste thus prepared was applied uniformly to both surfaces of a current collector using a nickel-plated punched metal. The paste on the current collector was then dried and rolled to prepare a negative electrode.

A non-woven fabric of polypropylene and polyethylen sulfonized by thick sulfuric acid was used as a separator S separating the positive electrode and the negative electrode.

An aqueous solution of 30 wt % potassium hydroxide prepared by adding 0.5 wt % of tungsten oxide WO₃ to the hydrogen absorbing alloy in the negative electrode was used as an alkaline electrolyte solution. The weight of tungsten element in the alkaline electrolyte solution was 0.40 wt % based on the weight of the hydrogen absorbing alloy.

A cylindrical nickel-metal hydride battery having a capacity of about 1000 mAh was fabricated using the positive electrode, the negative electrode, the separator S, and the alkaline electrolyte solution in the same manner as the Example A1.

### EXAMPLE C2

In Example C2, in the preparation of the positive electrode of Example C1, the coating layer of yttrium hydroxide Y(OH)₃ was not formed on the positive electrode active material which was filled into the sintered nickel substrate. Except for the above, the same procedure as that in the Example C1 was taken to fabricate a nickel-metal hydride battery of Example C2.

### EXAMPLE C3

In Example C3, a separator G prepared by graft polymerizing acrylic acid on a surface of the non-woven fabric of polypropylene and polyethylene was used in stead of the sulfonized separator S. Except for the above, the same procedure as that in the Example C1 was taken to fabricate a nickel-metal hydride battery of Example C3.

### EXAMPLE C4

In Example C4, in the preparation of the negative electrode of Example C1, 0.5 part by weight of tungsten oxide WO₃ was added to 100 parts by weight of the hydrogen absrobing alloy particles. Except for the above, the same procedure as that in the Example C1 was taken to prepare a negative electrode. In the negative electrode, the weight of tungsten element in the tungsten oxide WO₃ based on the hydrogen absorbing alloy was 0.40 wt %.

The aqueous solution of 30 wt % potassium hydroxide to which tungsten oxide WO₃ was not added was used as the alkaline electrolyte solution.

Except for the above, the same procedure as that in the Example C1 was taken to fabricate a nickel-metal hydride battery of Example C4 using the negative electrode and the alkaline electrolyte solution.

### EXAMPLE C5

In Example C5, the aqueous solution of 30 wt % potassium hydroxide prepared by adding 0.5 wt % of molybdenum oxide MoO₃ to the hydrogen absorbing alloy in the negative electrode was used as the alkaline electrolyte solution. The separator G prepared by graft polymerizing acrylic acid on the surface of a non-woven fabric of polypropylene and polyethylene was used as the separator separating the positive electrode and the negative electrode in the same manner as Example C3. The amount of molybdenum element in the alkaline electrolyte solution was 0.33 wt % based on the hydrogen absorbing alloy in the negative electrode.

Except for the above, the same procedure as that in the Example C1 was taken to fabricate a nickel-metal hydride battery of Example C4 using the separator G and the alkaline electrolyte solution to which molybdenum oxide MoO₃ was added.

### EXAMPLE C6

In Example C6, in the preparation of the negative electrode of Example C1, 0.5 part by weight of molybdenum oxide MoO₃ was added to 100 parts by weight of the hydrogen absorbing alloy particles. Except for the above, the same procedure as that in the Example C1 was taken to prepare a negative electrode. In the negative electrode, the weight of tungsten element in the tungsten oxide WO₃ based on the hydrogen absorbing alloy was 0.40 wt %.

The aqueous solution of 30 wt % potassium hydroxide to which neither tungsten oxide WO₃ nor molybdenum oxide MoO₃ was added was used as the alkaline electrolyte solution.

Except for the above, the same procedure as that in the Example C1 was taken to fabricate a nickel-metal hydride battery of Example C6 using the negative electrode and the alkaline electrolyte solution.

### COMPARATIVE EXAMPLE c1

In Comparative Example c1, in the preparation of the positive electrode of Example C1, the coating layer of yttrium hydroxide Y(OH)₃ was not formed on the positive electrode active material which was filled into the sintered nickel substrate, and the aqueous solution of 30 wt % potassium hydroxide to which tungsten oxide WO₃ was not added was used as the alkaline electrolyte solution. Except for the above, the same procedure as that in the Example C1 was taken to fabricate a nickel-metal hydride battery of Comparative Example c1.

### COMPARATIVE EXAMPLE c2

In Comparative Example c2, in the preparation of the positive electrode of Example C1, the coating layer of yttrium hydroxide Y(OH)3 was hot formed on the positive electrode active material which was filled into the sintered nickel substrate, and the separator G prepared by graft polymerizing acrylic acid on the surface of the non-woven fabric of polypropylene and polyethylene was used as the separator separating the positive electrode and the negative electrode in the same manner as the Example C3. Except for the above, the same procedure as that in the Example C1 was taken to fabricate a nickel-metal hydride battery of Comparative Example c2.

### COMPARATIVE EXAMPLE c3

In Comparative Example c3, the aqueous solution of 30 wt % potassium hydroxide to which tungsten oxide WO₃ was not added was used as the alkaline electrolyte solution, and the separator G prepared by graft polymerizing acrylic acid on the surface of the non-woven fabric of polypropylene and polyethylene was used as the separator separating the positive electrode and the negative electrode in the same manner as the Example C3. Except for the above, the same procedure as that in the Example C1 was taken to fabricate a nickel-metal hydride battery of Comparative Example c3.

### COMPARATIVE EXAMPLE c4

In Comparative Example c4, in the preparation of the positive electrode of Example C1, the coating layer of yttrium hydroxide Y(OH)₃ was not formed on the positive electrode active material which was filled into the sintered nickel substrate, the aqueous solution of 30 wt % potassium hydroxide to which tungsten oxide WO₃ was not added was used as the alkaline electrolyte solution, and the separator G prepared by graft polymerizing acrylic acid on the surface of the non-woven fabric of polypropylene and polyethylene was used as the separator separating the positive electrode and the negative electrode in the same manner as the Example C3. Except for the above, the same procedure as that in the Example C1 was taken to fabricate a nickel-metal hydride battery of Comparative Example c4.

Each of the nickel-metal hydride batteries of Example C1 to C6 and Comparative Examples c1 to c4 thus fabricated was charged at 100 mA for 16 hours, and then discharged at 100 mA to 1.0 V under a temperature condition of 25° C. The above-mentioned charging and discharging was considered as one cycle. 10 cycles of the charging and discharging were performed, so as to activate each of the nickel-metal hydride batteries of Example C1 to C6 and Comparative Examples c1 to c4.

Each of the nickel-metal hydride batteries of Example C1 to C6 and Comparative Examples c1 to c4 thus activated was charged at 3000 mA for 12 minutes, and was discharged at 3000 mA to 1.0 V, under the temperature condition of 45° C. The above-mentioned charging and discharging was considered as one cycle. Each of the nickel-metal hydride batteries was subject to repeated charging and discharging processes, so as to determine number of the cycles at which the discharge capacity of the batteries became 580 mAh. The results were shown in the following Table 3.

TABLE 3

| | type | Y(OH)₃ | | | | number |
|---|---|---|---|---|---|---|
| | of | in | | | W or | of |
| | sepa- | positive | additive | | Mo | cycles |
| | rator | electrode | type | place | (wt %) | (times) |
| Example C1 | S | Yes | WO₃ | electrolyte | 0.40 | 762 |
| | | | | solution | | |
| Example C2 | S | No | WO₃ | electrolyte | 0.40 | 731 |
| | | | | solution | | |
| Example C3 | G | Yes | WO₃ | electrolyte | 0.40 | 722 |
| | | | | solution | | |
| Example C4 | S | Yes | WO₃ | negative | 0.40 | 760 |
| | | | | electrode | | |
| Example C5 | G | Yes | MoO₃ | electrolyte | 0.33 | 720 |
| | | | | solution | | |
| Example C6 | S | Yes | MoO₃ | negative | 0.33 | 765 |
| | | | | electrode | | |
| Comparative | S | No | — | — | — | 649 |
| Example c1 | | | | | | |
| Comparative | G | No | WO₃ | electrolyte | 0.40 | 647 |
| Example c2 | | | | solution | | |
| Comparative | G | Yes | — | — | — | 638 |
| Example c3 | | | | | | |
| Comparative | G | No | — | — | — | 620 |
| Example c4 | | | | | | |

As apparent from the results, the nickel-metal hydride batteries of Example C1 to C6 using one of the alkaline electrolyte solution and the negative electrode to which tungsten oxide WO₃ or molybdenum oxide MoO₃ was added, and satisfying at least one of the following conditions of using the sulfonized separator S and forming the coating layer of yttrium hydroxide Y(OH)₃ on the positive electrode active material, presented an improved cycle characteristics compared with the nickel-metal hydride battery of Comparative Examples c1 to c4.

According to a comparison among the nickel-metal hydride batteries of Examples C1 to C6, the nickel-metal hydride batteries of Examples C1, C4, and C6 using one of the alkaline electrolyte solution and the negative electrode to which tungsten oxide WO₃ or molybdenum oxide MoO₃ was added, using the sulfonized separator S, and having the coating layer of yttrium hydroxide Y(OH)₃ formed on the positive electrode active material presented further improved cycle characteristics.

### EXAMPLES C1.1 to C1.4

In Examples C1.1 to C1.4, the amount of tungsten oxide WO₃ to be added to the alkaline electrolyte solution in Example C1 was changed. Except for the above, the same procedure as that in the Example C1 was taken to fabricate each of nickel-metal hydride batteries of Examples C1.1 to C1.4.

Specifically, the amount of tungsten oxide WO₃ to be added to the alkaline electrolyte solution based on the hydrogen absorbing alloy in the negative electrode was respectively 0.1 wt % in Example C1.1, 0.2wt % in Example C1.2, 0.25wt % in Example C1.3, and 0.75 wt % in Example C1.4. The amount of tungsten element in each of the above-mentioned alkaline electrolyte solutions based on the amount of the hydrogen absorbing alloy in the negative electrode was respectively 0.08 wt % in Example C1.1, 0.16 wt % in Example C1.2, 0.20 wt % in Example C1.3, and 0.59 wt % in Example C1.4 as shown in the following Table 4.

Number of the cycles of each of the nickel-metal hydride batteries of Examples C1.1 to C1.4 at which the discharge capacity thereof became 580 was determined in the same manner as the nickel-metal hydride battery of Example C1. The results along with that of Example C1 were shown in the following Table 4.

TABLE 4

| | type | Y(OH)₃ | | | | number |
|---|---|---|---|---|---|---|
| | of | in | | | W or | of |
| | sepa- | positive | additive | | Mo | cycles |
| | rator | electrode | type | place | (wt %) | (times) |
| Example C1.1 | S | Yes | WO₃ | electrolyte | 0.08 | 697 |
| | | | | solution | | |
| Example C1.2 | S | Yes | WO₃ | electrolyte | 0.16 | 714 |
| | | | | solution | | |
| Example C1.3 | S | Yes | WO₃ | electrolyte | 0.20 | 719 |
| | | | | solution | | |
| Example C1 | S | Yes | WO₃ | electrolyte | 0.40 | 762 |
| | | | | solution | | |
| Example C1.4 | S | Yes | WO₃ | electrolyte | 0.59 | 676 |
| | | | | solution | | |

As apparent from the results, the nickel-metal hydride batteries of Examples C1.1 to C1.4 in which the weight of tungsten element in the alkaline electrolyte solution based on the weight of the hydrogen absorbing alloy was changed to the range of 0.08 to 0.59 wt % presented the improved cycle characteristics compared with the nickel-metal hydride batteries of Comparative Examples c1 to c4. Especially, the nickel-metal hydride battery of Examples C1 in which the weight of tungsten element in the alkaline electrolyte solution based on the weight of the hydrogen absorbing alloy was in the range of 0.3 to 0.4 wt % presented an extremely improved cycle characteristics.

### INDUSTRIAL APPLICABILITY

As specifically described above, in a nickel-metal hydride battery of a first aspect of the invention, molybdenum is added to a negative electrode using hydrogen absorbing alloy, therefore, a surface of the hydrogen absorbing alloy is activated for the effect of molybdenum and discharge characteristics of the nickel-metal hydride battery are modified, and especially, even in use of the nickel-metal hydride battery under low temperature, sufficient discharge capacity is attained.

In a nickel-metal hydride battery according to a second aspect of the invention, hydroxide and/or oxide of at least one element selected from calcium, strontium, scandium, yttrium, lanthanoid, and bismuth is added to a positive electrode using nickel hydroxide, and molybdenum is added to at least one of a negative electrode using hydrogen absorbing alloy and an alkaline electrolyte solution, therefore, a surface of the hydrogen absorbing alloy is activated for the effect of the molybdenum thus added, and discharge characteristics of the nickel-metal hydride battery are modified in the same manner as the nickel-metal hydride battery of the first aspect. In addition, generation of oxygen in the positive electrode during charge or storage is prevented for the effect of the hydroxide and/or oxide of at least one element selected from calcium, strontium, scandium, yttrium, lanthanoid, and bismuth thus added to the positive electrode, and oxidation of the hydrogen absorbing alloy in the negative electrode is prevented, thus cycle characteristics of the nickel-metal hydride battery are improved.

In a nickel-metal hydride battery according to a third aspect of the invention, hydroxide and/or oxide of at least one element selected from calcium, strontium, scandium, yttrium, lanthanoid, and bismuth is added to a positive electrode using nickel hydroxide, and tungsten is added to at least one of a negative electrode and an alkaline electrolyte solution, therefore, generation of oxygen in the positive electrode during charge or storage is prevented, and oxygen reacts with hydrogen in the negative electrode and is consumed for catalysis of the tungsten added to the negative electrode or the alkaline electrolyte solution, thus oxidation and degradation of the hydrogen absorbing alloy in the negative electrode is prevented, storage characteristics of the nickel-metal hydride battery are extremely improved, and even in the storage under high temperature, decrease of capacity by self discharge is declined, and cycle characteristics of the nickel-metal hydride battery are improved.

In a nickel-metal hydride battery according to a fourth aspect of the invention, sulfonized olefinic resin is used as a separator separating a positive electrode and a negative electrode, and at least one of molybdenum and tungsten is added to at least one of the negative electrode and an alkaline electrolyte solution, therefore, an affinity of the separator for the alkaline electrolyte solution is improved, thus self discharge is prevented and cycle characteristics are improved, in addition, oxygen which generates in the positive electrode reacts with hydrogen in the negative electrode and is consumed for catalysis of the molybdenum or the tungsten added to the negative electrode or the alkaline electrolyte solution, as a result, oxidation and degradation of the separator or the hydrogen absorbing alloy in the negative electrode is prevented, storage characteristics of the nickel-metal hydride battery are extremely improved, and cycle characteristics of the nickel-metal hydride battery are greatly improved.

1. A nickel-metal hydride battery provided with a positive electrode using nickel hydroxide, a negative electrode using hydrogen absorbing alloy which comprises Mm (misch metal), Ni, Co, Al, and Mn, an alkaline electrolyte solution, and a separator separating the positive electrode and the negative electrode, wherein
molybdenum is added to said negative electrode.

2. The nickel-metal hydride battery according to claim 1, wherein
hydroxide and/or oxide of said molybdenum is added to the negative electrode.

3. The nickel-metal hydride battery according to claim 1, wherein
said positive electrode is a sintered nickel electrode.

4. A nickel-metal hydride battery provided with a positive electrode using nickel hydroxide, a negative electrode using hydrogen absorbing alloy, an alkaline electrolyte solution, and a separator separating the positive electrode and the negative electrode, wherein
hydroxide and/or oxide of at least one element selected from calcium, strontium, scandium, yttrium, lanthanoid, and bismuth is added to the positive electrode, and molybdenum is added to at least one of the negative electrode and the alkaline electrolyte solution.

5. The nickel-metal hydride battery according to claim 4, wherein
at least a part of a surface of the nickel hydroxide in said positive electrode is coated with the hydroxide and/or oxide of at least one element selected from calcium, strontium, scandium, yttrium, lanthanoid, and bismuth.

6. The nickel-metal hydride battery according to claim 4, wherein
at least a part of the surface of the nickel hydroxide in said positive electrode is coated with the hydroxide and/or oxide of yttrium.

7. The nickel-metal hydride battery according to claim 4, wherein
hydroxide and/or oxide of said molybdenum is added to at least one of the negative electrode and the alkaline electrolyte solution.

8. The nickel-metal hydride battery according to claim 4, wherein
said positive electrode is a sintered nickel electrode.

9. A nickel-metal hydride battery provided with a positive electrode using nickel hydroxide, a negative electrode using hydrogen absorbing alloy, an alkaline electrolyte solution, and a separator separating the positive electrode and the negative electrode, wherein
hydroxide and/or oxide of at least one element selected from calcium, strontium, scandium, yttrium, lanthanoid, and bismuth is added to the positive electrode, and tungsten is added to at least one of the negative electrode and the alkaline electrolyte solution.

10. The non-aqueous electrolyte secondary battery according to claim 9, wherein
at least a part of a surface of the nickel hydroxide in said positive electrode is coated with the hydroxide and/or oxide of at least one element selected from calcium, strontium, scandium, yttrium, lanthanoid, and bismuth.

11. The nickel-metal hydride battery according to claim 10, wherein
at least a part of the surface of the nickel hydroxide in said positive electrode is coated with the hydroxide and/or oxide of yttrium.

12. The nickel-metal hydride battery according to claim 9, wherein
hydroxide and/or oxide of said tungsten is added to at least one of the negative electrode and the alkaline electrolyte solution.

13. The nickel-metal hydride battery according to claim 9, wherein
said positive electrode is a sintered nickel electrode.

14. A nickel-metal hydride battery provided with a positive electrode using nickel hydroxide, a negative electrode using hydrogen absorbing alloy, an alkaline electrolyte solution, and a separator separating the positive electrode and the negative electrode, wherein
sulfonized olefinic resin is used as said separator, and at least one of molybdenum and tungsten is added to at least one of said negative electrode and said alkaline electrolyte solution.

15. The nickel-metal hydride battery according to claim 14, wherein
hydroxide and/or oxide of said molybdenum or said tungsten is added to at least one of the negative electrode and the alkaline electrolyte solution.

16. The nickel-metal hydride battery according to claim 14, wherein
total amount of said molybdenum and tungsten based on weight of the hydrogen absorbing alloy in said negative electrode is in a range of 0.08 to 0.59 wt %.

17. The nickel-metal hydride battery according to claim 14, wherein
hydroxide and/or oxide of at least one element selected from calcium, strontium, scandium, yttrium, lanthanoid, and bismuth is added to said positive electrode.

18. The nickel-metal hydride battery according to claim 17, wherein
at least a part of a surface of the nickel hydroxide in said positive electrode is coated with the hydroxide and/or oxide of at least one element selected from calcium, strontium, scandium, yttrium, lanthanoid, and bismuth.

19. The nickel-metal hydride battery according to claim 18, wherein
at least a part of the surface of the nickel hydroxide in said positive electrode is coated with the hydroxide and/or oxide of yttrium.

20. The nickel-metal hydride battery according to claim 14, wherein
said positive electrode is a sintered nickel electrode.
